(19) United States
(12) Patent Application Publication
(10) Pub. No.: US 2003/0115108 A1
(43) Pub. Date: Jun. 19, 2003

(54) Method and system for designing and ordering products for manufacture on-line

(76) Inventors: William Scott, Weidman, MI (US); John Mozurkewich, Mt. Pleasant, MI (US); Jeffrey LaBean, Pinconning, MI (US)

Correspondence Address: BAKER & MCKENZIE, 805 THIRD AVENUE, NEW YORK, NY, 10022, US

(21) Appl. No.: 10/024,109

(22) Filed: Dec. 17, 2001

(51) Int. Cl. G06F 17/60

(52) U.S. Cl. 705/26

(57) ABSTRACT

A method and system for designing equipment for manufacture and generating drawings on-line. A customer logs on to the system via a World Wide Web or other network connection and is presented with a list of equipments to configure and design. When the customer selects equipment, the system prompts the customer to enter various parameters and guides the customer through the design. The system automatically generates a drawing based on the customer-entered parameters. At the same time, all necessary parts drawings are computed and completed, ready for manufacturing of the equipment without needing additional information from the customer. Design specification drawing based on the customer-entered parameters that are automatically generated are sent to the customer over the network or via facsimile.

### TECHNICAL FIELD OF THE INVENTION

The present invention relates generally to equipment design and production, and particularly, to a system and method for designing, customizing, and ordering products on-line.

### BACKGROUND OF THE INVENTION

Typically, when a customer desires to order customized equipment for his or her business needs, the customer must first engage a sales person from the equipment manufacturer and provide the design specification including various configuration parameters for the equipment to fit the customer's business needs to the sales person. The sales person then takes the configuration parameters and provides them to a design engineer who designs the equipment, typically with aid of CAD/CAM (computer-aided drafting/computer aided manufacturing) tools. If the customer approves the design plan, the plan is sent to the manufacturing plant where the equipment is built according to its design specification.

This serialized process tends to be slow and does not provide the customer with feedback or status information of what is going on with the customer's design plan or order. Thus, a more convenient method and system is needed to improve the old process of designing and ordering customized products.

### SUMMARY OF THE INVENTION

According to the present invention, a World Wide Web (“web”) interface system and method for designing, customizing, and ordering products on-line for manufacture is provided. An authorized user logs on with a user name and password to a web site provided in the system of the present invention. E.g., any user on the Internet using the Hypertext Transfer Protocol (HTTP) may access the site. Once the user is authenticated, the user is presented with a display from which the user may select a number of options for performing desired functions. One such option is for configuring an equipment or product design. On the web page, the user provides a number of predetermined parameters, including the type of equipment or product the user is configuring and submits the data to the remote engineering site where a drawing according to the user submitted data is drafted and e-mailed back to the user in real time. At the time the drawing is generated, all data relating to manufacturing of the equipment is generated and stored in a database where a manufacturing system may access later when manufacturing the equipment. Once the user decides to place an order for the equipment, e.g., after the user reviews the e-mailed design specification and approves it, the user can order the product for manufacture from the same web site or web page that the user used to configure the product.

In one aspect of the present invention, the user is also given various options to view status of the order and production stages, get a copy of the drawings e-mailed again, and gather information to obtain a quote for all the configured products.

In another aspect, the present invention includes an automated system remotely located from the user, for receiving in real time, the configuration data from the user, setting up the data, and building the design specification. The system may also send the newly designed specification or a plan of the equipment, if the user requests a drawing of the design specification.

This way, a customer at the customer's site can provide design specification data for customized equipments, view the design specification drawing, and if satisfied, order the equipment for manufacturing. The customer can also view the status of the order from the time of ordering until the equipment is manufactured and ready for delivery.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 is a flow diagram illustrating the logon procedure and options that a customer may perform in one embodiment of the present invention;

FIG. 2 is a flow diagram that illustrates different options under the administrative function which a customer may elect to perform;

FIG. 3 is a flow diagram illustrating the program logic in one embodiment for presenting new announcements to customers;

FIG. 4 is a flow diagram illustrating the program logic in one embodiment for presenting recent sessions information;

FIG. 5 is a flow diagram illustrating the program logic for computing and viewing quotes related to customer's orders;

FIG. 6 is a flow diagram illustrating the program logic for presenting order information in one embodiment;

FIG. 7 is a flow diagram illustrating the program logic in one embodiment of the present invention for allowing customers to receive a copy of the configured equipment drawings;

FIG. 8 is a flow diagram illustrating the program logic for allowing customers to perform additional administrative functions related to their orders;

FIG. 9 is a flow diagram illustrating the configuration procedure in one embodiment;

FIG. 10 is a flow diagram in one embodiment of the present invention illustrating the automated generation of the drawings according to the user input configuration parameters;

FIG. 11 is a flow diagram illustrating the ordering process in one embodiment of the present invention; and

FIG. 12 shows an exemplary system of the present invention in one embodiment.

### DETAILED DESCRIPTION OF THE INVENTION

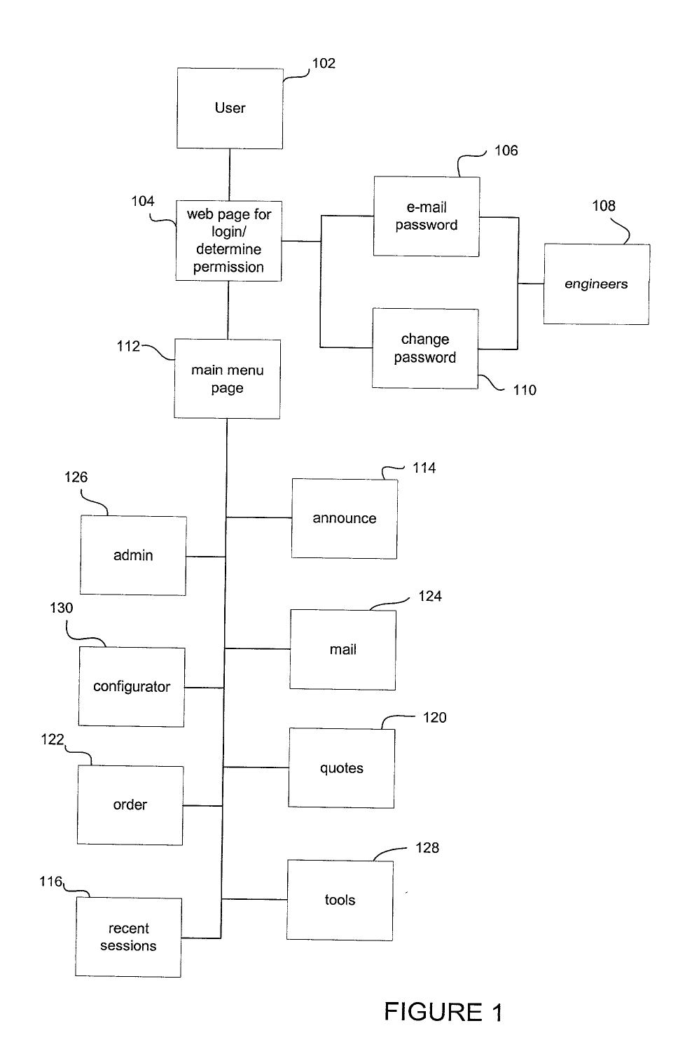

FIG. 1 is a flow diagram illustrating the logon procedure and options that a customer may perform in one embodiment of the present invention. At 102, a user or customer logs on to a web site provided in the present invention, by entering user name and password that is assigned to the user. At 104, the web page for log-in checks the user's permission based on the user-entered name and password. E.g., a database table shown at 108 may include username/password information for all authorized users, and may be used to authenticate or validate the user onto the system.

If the user has forgotten the password, the user may click on, e.g., “forgot password” hyperlink on the log-on page. In this case, the password may be obtained from the same database table 108, and a hint that would remind the user of the password may be mailed electronically to the user as shown at 106.

Similarly, if the user desires to change the password, the user may click on the “change password” hyperlink and enter a new password when prompted. The database 108 would then be updated with the new password for the user as shown at 110.

Once the user is authenticated or validated into the system, at 112, a main menu page having a list of functions that can be performed as well as additional useful information may be displayed. E.g., in an announcements box 114, new information may be displayed. Similarly, in a menu box, a list of recent sessions that the user did not complete previously may be displayed as shown at 116. Hyperlinks on this menu may be selected to continue the session or to delete the incomplete session and start over again. The quotes option at 120 allows the customer to view the price quote for all the items ordered. The orders option at 122 allows designated administrators to view information about their orders. E.g., a customer may select to inquire about the job status, request another copy of the drawings, or print a copy of the drawings.

At 126, the administrative tools allow customers to access accounting information, setup access permissions and user groups. Via the configurator options at 130 on the main menu page, a customer may begin configuring or designing various equipments available as hyperlinks. E.g., the configurator box may list a number of different food service equipments to configure and design, including serving equipments, refrigerators and heating units, mobile carts, ventilation equipment, and other customized equipment. At 128, the tools option allows customers to view and control the queue of orders and their status in the production line. Each of these options will now be described in more detail with reference to the following figures.

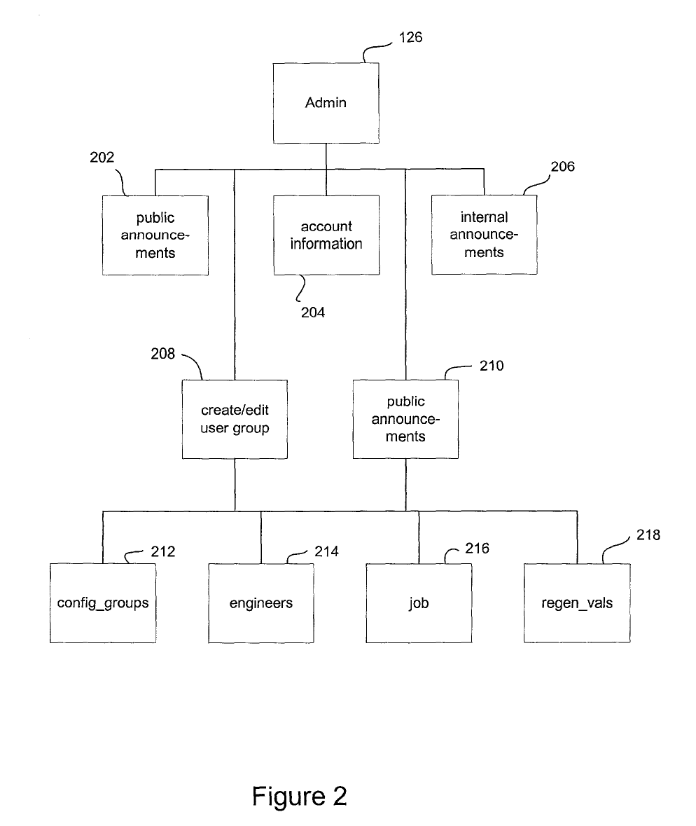

FIG. 2 is a flow diagram that illustrates different options under the administrative function which a customer may elect to perform. Under the admin option 126 shown in FIG. 1, a customer is allowed to perform a number of sub-functions. These sub-functions include viewing public announcements 202, account information 204, and internal announcements 206. Additional sub-functions include ability to create or edit user groups at 208, and to edit external public announcements 210. Selecting the account information 204, e.g., may display all the parts and models designed and ordered by the customer. Via the create or edit user group 208, a new user may be created and permission levels of existing users may be changed. The external public announcements 210 are typically visible to all users. Internal announcements 206 are directed typically to internal or privileged users, e.g., to employees of an organization or an engineering group.

The data stored in the config_groups, engineers, and job, and regen_vals database tables are used to process the administrative tools functions. Briefly, the config_groups table may hold data related to access permissions for each group. The access permission controls the maximum access level that a member is allowed exercise when configuring user accounts for a group. Full administrators with the highest level of access may add groups, and set group permissions. Group administrators may add users to their group. The permission level may be set up to but not exceeding the permission level of the entire group.

The engineers table is used to generate a selectable list of persons that can configure an order. For the new configurator, this table also holds attributes for each user including their web access password, access level rights, e-mail address, etc. The regen_vals table holds all the configuration selections the user made in the model configuration pages. The data in the regen_vals are also used by a CAD/CAM tool to generate and regenerate the design models.

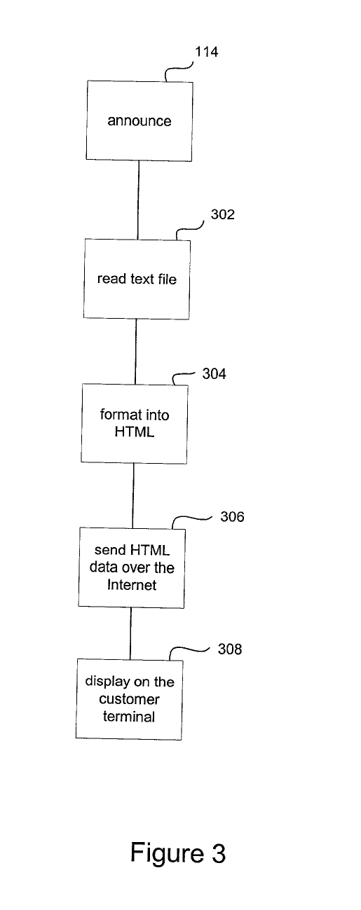

FIG. 3 is a flow diagram illustrating the program logic in one embodiment for presenting new announcements to customers, e.g., on the main menu page. At 302, a text file containing the announcement text is read. At 305, the text is converted into an appropriate format, e.g., Hypertext Markup Language (HTML) for display by a web browser. At 306, the text data in appropriate format is transmitted to the customer's location, e.g., over the Internet using HTTP protocol, where the customer's web browser can display the announcement as shown at 308. The displayed announcements are changed, e.g., by updating the text file with new information.

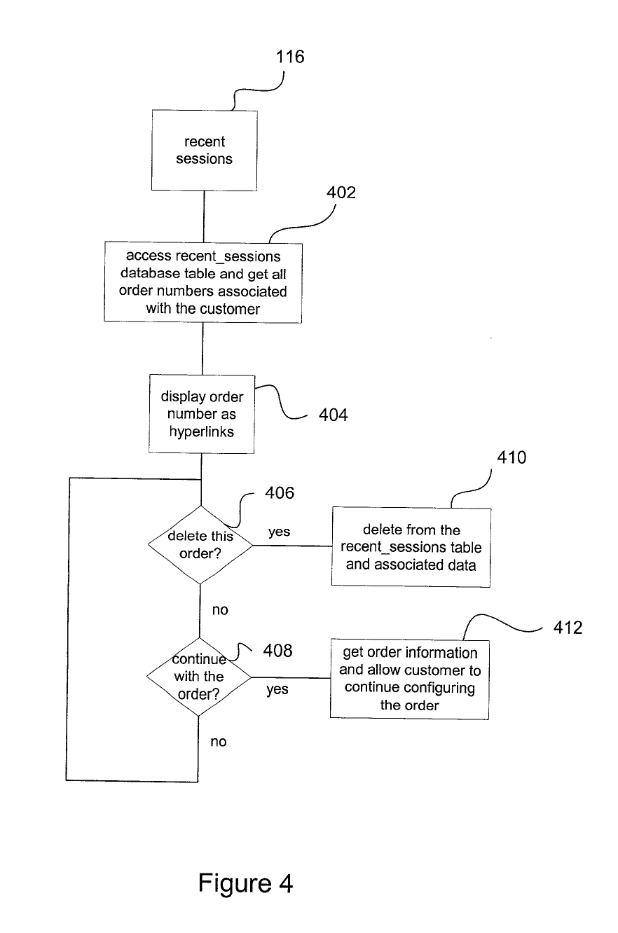

FIG. 4 is a flow diagram illustrating the program logic in one embodiment for presenting recent sessions information. As described above with reference to FIG. 1 at 116, a pop up menu or a menu box may list recent sessions that the user did not complete previously and from which the user may continue the session. In one embodiment, the list is displayed by order numbers as hyperlinks from which, if clicked, a customer may continue with the order session from the point where the customer left off previously. A delete hyperlink associated with each order number is also displayed, providing the customer with an option to delete the previously incomplete session. At 402, equipments configured in previous sessions but have not been completed or not yet ordered are retrieved from a database table, e.g., “recent_sessions” table. These previous orders are listed by order numbers and are displayed as hyperlinks in one embodiment at 404. Also, associated with each order number is a “delete” hyperlink button. At 406, if this “delete” button is clicked, the data associated with this order is removed from the “recent_sessions” database table with any other data associated with the order. At 408, if one of the order number is clicked, representing that a customer desires to continue or view the order associated with the clicked order number, information relating to the order is retrieved and displayed at 412. In one embodiment, the page displayed is the page which the customer left off in the last session. The customer then may continue configuring the equipment by entering or modifying parameters associated with this equipment configuration.

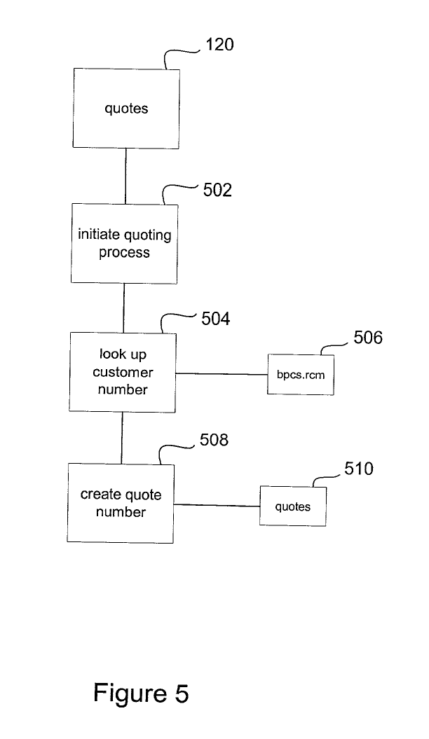

FIG. 5 is a flow diagram illustrating the program logic for computing and viewing quotes related to customer's orders. Selecting the quotes option at 120 (FIG. 1) causes a quoting process to be initiated at 502. The quoting process includes looking up the customer number at 504 in the customer number database at 506. At 508, a quote number associated with the customer is created and a quote for the entire inventory of ordered or designed items are calculated and displayed. This quote information then may be stored in the quotes database table 510 for later use.

The main page may also include options for allowing customers to view information about their orders as shown at 122 (FIG. 1). The order information includes data associated with the order such as type of order, dates when the order was configured, created, mailed, or archived. E.g., a customer may configure equipment and obtain a quote for the configured equipment but not actually order the equipment to be manufactured and delivered. If the configured equipment is not ordered within a day after being configured, the drawing may be saved and archived for later retrieval. Other data include parts information that describes the assembly parts for the ordered equipment. In addition, a customer may select to inquire about the job status, request another copy of the drawings, or print a copy of the drawings.

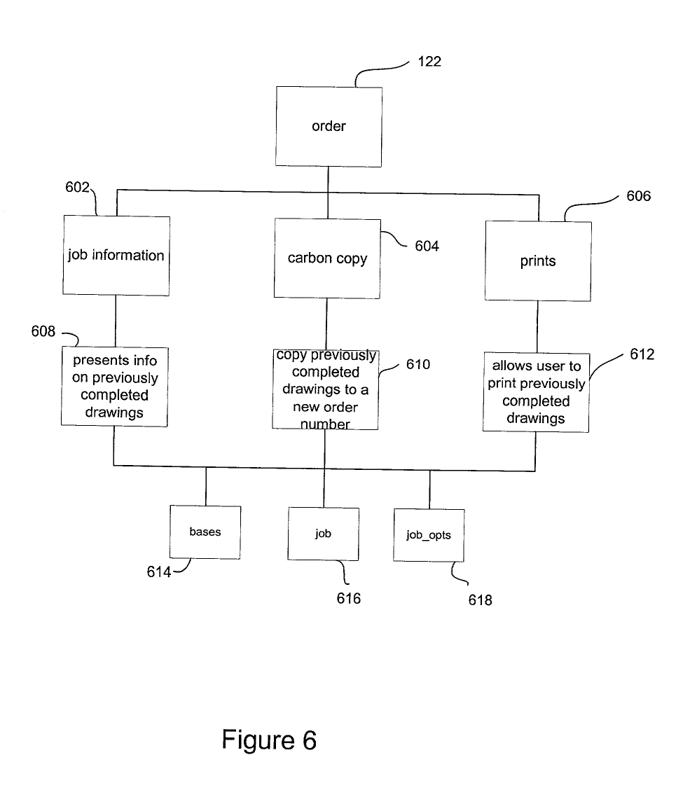

FIG. 6 is a flow diagram illustrating the program logic for presenting order information in one embodiment. At 602, if an inquiry about the job status is requested, at 608 information related to completed drawings or orders are presented by retrieving and gathering the information from the “bases” 614, “job” 616, and “job_opts” 618 database tables. The bases table holds which models a user or customer has selected, and what position they are in. The position of the models refers to the location within a line of equipment for a given base unit. E.g., in one embodiment of present invention, a customer is allow to build an equipment by combining several base units under a common top, or on a common set of leg rails. This combination results in the creation of one piece of equipment that is made of several modules. An example is a unit that has a dry storage area on the left, followed by an under counter refrigerator, followed by a hot food table all combined into one unit. The dry storage may be in position 1, the refrigerator in position 2, and the hot food table in position 3.

The job table contains the generic data about user's configuration such as name, dates for building, shipping, and mailing. The “job_opts” table contains basic options the user selected when configuring the order, such as type of model, printer, plotter, e-mail address for drawings to be sent to, facsimile numbers for drawings to be facsimiled, and quantity of prints to be generated.

At 604, the customer may also request a carbon copy of the previously ordered drawing. At 610, a copy of previously completed drawing is assigned to a new order number. With the carbon copy feature, a user may create an exact copy of a pre-existing configured order. The user starts by entering in the existing order number. The user may also specify the new number, and other options such as printer or plotter to use. When the carbon copy request is submitted, the backend web page programming of the present invention copies the necessary database information from the original order to the new order and then makes a queue entry to complete the processing as a normal new order configuration. The order associated with this new order number will typically have the same user supplied configuration parameters as the original from which a copy was made. In processing carbon copy function, the database tables “bases” 614, “job” 616, and “job_opts” 618 may be read and written to.

Also at 606, the customer may request another print copy of the drawings. At 612, copies of previously completed drawings are sent to a printer or plotter designated by the customer. In processing carbon copy function, the database tables “bases” 614, “job” 616, and “job_opts” 618 may be read and written to.

Another option available to the customer from the main page may include the mail option 124 (FIG. 1) in which the drawing is sent, e.g., e-mailed to the customer. In one embodiment of the present invention, the customer receives the e-mail or facsimile copy of the configure equipment specification as soon as the customer completes configuring the order and submits the order for drafting. The configured parameters are transmitted to a drafting tool in the present invention and the drawing produced within, e.g., a few minutes of time, whereupon the customer receives the drawing via e-mail or facsimile. The bases, job, and job_opts database tables are used to extract data necessary for performing this function. Briefly, the bases table holds which models a user has selected, and what position in the equipment they are in. The job table contains the generic data about a user's configuration such as name, dates for building, shipping, and mailing. The job_opts table contains basic options the user selected when configuring the order such as the type of model, printer, plotter, e-mail addresses for forwarding the completed drawing, facsimile numbers, and quantity of drawings to be run.

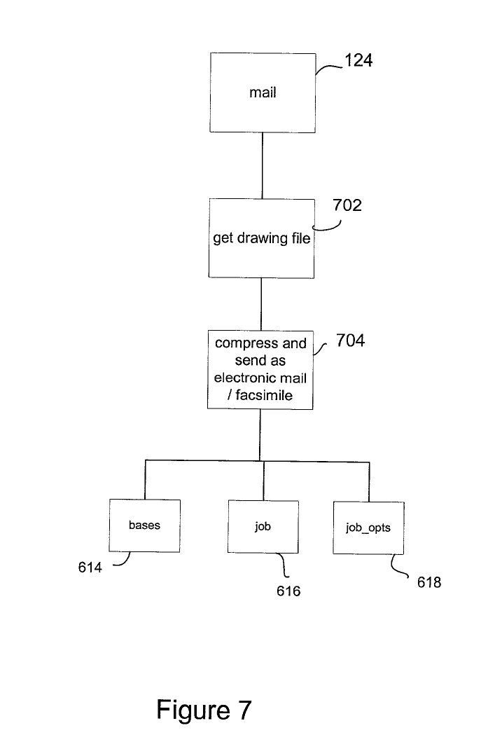

FIG. 7 is a flow diagram illustrating the program logic in one embodiment of the present invention for allowing customers to receive a copy of the configured equipment drawings. At 702, the completed drawing is retrieved. At 704, the retrieved drawing is transmitted to the customer via e-mail or facsimile. The bases 614, job 616, and job_opts 618 database tables are updated with the current information, e.g., the date and time the drawing was e-mailed or facsimiled to the customer.

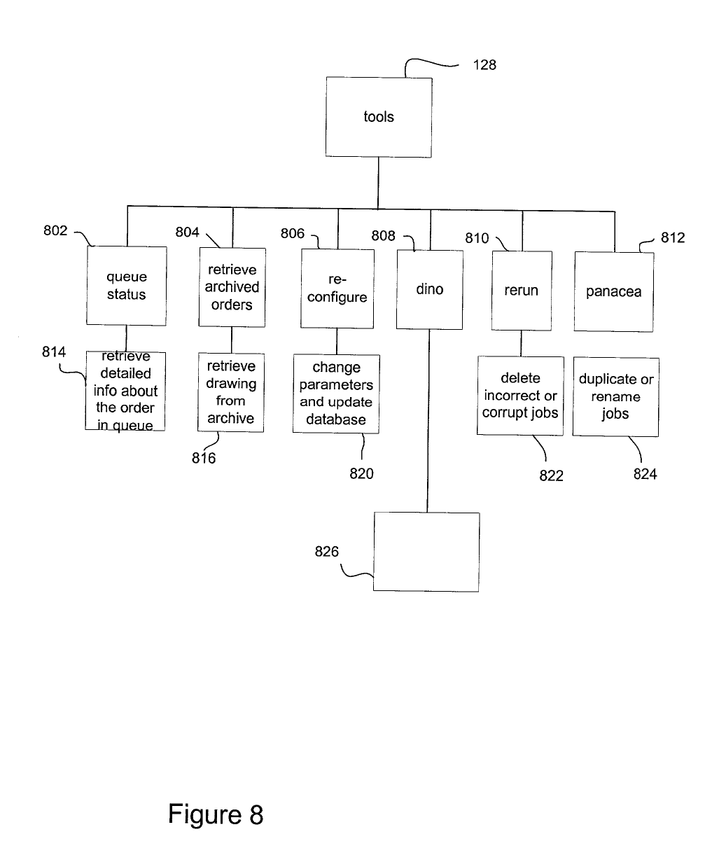

The tools option on the main page also allows the customer to perform myriad of functions. These functions include viewing queue status, retrieving archived orders, reconfiguring the existing order, creating shop prints, rerunning the order, and copying and renaming of an existing order to a new order. FIG. 8 is a flow diagram illustrating the program logic for allowing customers to perform additional administrative functions related to their orders. At 802, if the queue status is selected, a detailed list of the queue in the production order is retrieved and shown at 814. The status also may include how much work on the ordered equipment has been done on a given day and how much is scheduled to be done in a given week. At 804, if archive retrieval is selected, the customer is prompted to enter the order number or series of order numbers. Then the order is retrieved from the archive at 816. E.g., if a customer configured the equipment but has not yet ordered it, the drawing or the specification for the order may be archived even after, e.g., a day has passed. After the one day has passed, if the customer is still interested in the configured equipment, the customer may retrieve the order from the archive by using this function.

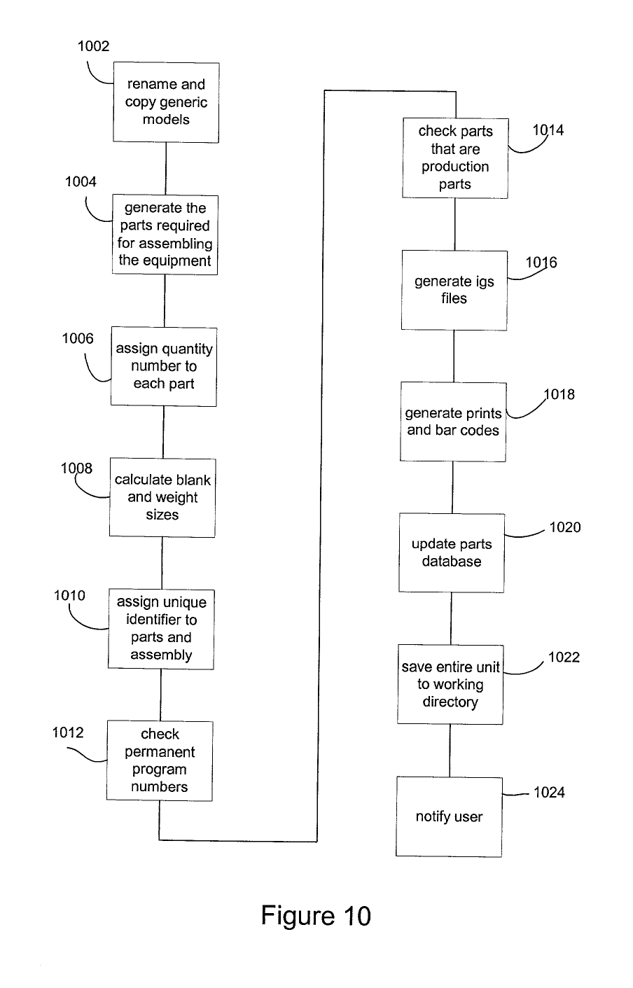

At 806, if reconfigure option is selected, the customer may change previously entered parameters at 820. At the same time, associated database tables are updated. At 808, if “shop prints” option is selected, piece part prints are generated and sent to shop for production. E.g., piece part prints are generated and sent to shop for production. This process is described in more detail with reference to FIG. 10. The rerun option at 810 allows customers to delete incorrect geometry or corrupt jobs that cannot be retrieved as shown at 822. The panacea option at 812 allows customers to re-name or duplicate an order as shown at 824.

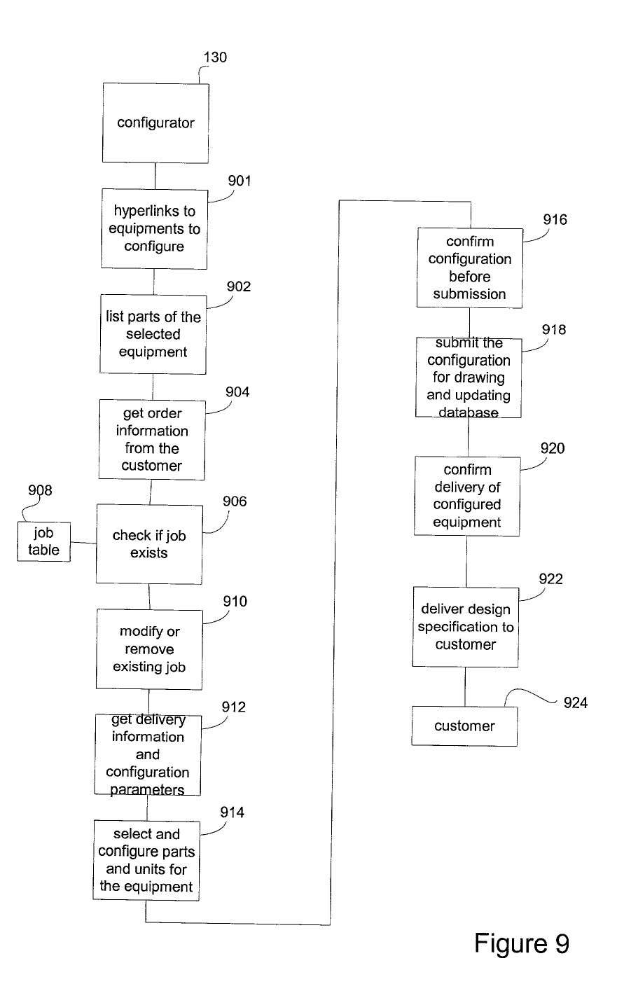

FIG. 9 is a flow diagram illustrating the equipment configuration in one embodiment. The main menu shown in FIG. 1 may include a configure pop up menu or a menu box that list a number of equipments that may be configured. The list of equipments may be presented as hyperlinks at 901 which the customer may click to select the desired equipment for configuration. At 902, when a user selects to configure, e.g., ventilation equipment, a new menu box pops up with a list of available units that are associated with the ventilation equipment. At 904, the user selects the unit by, e.g., clicking on the item. Examples of different units include single hood ventilator, multiple hood ventilator, and accessory parts associated with the ventilation equipment. In one embodiment, these items may appear graphically on the customer's display to visually aid the customer in selecting the correct equipment for the customer's needs.

Once the user selects the unit, the user is prompted to enter an order number for the current order. At 906, the user-entered order number is checked against the job database table 908. If the order number already exists, at 910, the information associated with the order number is displayed, allowing the user to modify or remove the item associated with the order number.

If the order number is new, then at 912, the user is prompted to enter the delivery address, e.g., e-mail address, facsimile number where the completed design drawing may be sent, quantity of drawings, and type of drawing package desired. At 912, the user is guided through series of prompts to select and configure each part of the item selected. The parts may be displayed as graphical images to give the user visual aid in selecting different parts of the item. In configuring, the user is prompted to enter parameters such as length, depth, style, and other variable parameters needed to configure the equipment. The user may also enter a ship date for shipping the manufactured item.

At 916, the configuration data for the design is displayed for the user to review and submit to engineering for drawing and processing. Also shown on this display are hyperlinks that list the series of pages or menu boxes that the user has already processed and passed. By clicking on any one of the hyperlinks, the user is allowed to go back, review and change any of the configurations or entries entered on the previous pages or menu boxes. At 918, when the user clicks on a submit button, the configuration data is transmitted to an engineering system where the data is used to generate the drawing. At 920, confirmation is displayed to the user that the drawing is on its way via either e-mail or facsimile or any other means specified by the user. At 924, when the drawing is complete, a copy is e-mailed or facsimiled to the customer 226. The turn around time between the time the customer first configured an order and the time the customer receives the designed drawing for the order may be as quick as five minutes.

At 918, when the user clicks on the submit button, an automated process is initiated for generating the drawings. FIG. 10 is a flow diagram in one embodiment of the present invention illustrating the automated generation of the drawings according to the user input configuration parameters. At 1002, available generic models are renamed and copied. At 1004, a computer aided tool is started to generate the parts required for assembling the equipment, i.e., each part required in the equipment is drawn to the size. At 1006, each part is assigned a quantity number. At 1008, blank sizes and weights are calculated, including the finished part weight, and the weight of a rectangular steel blank required to manufacture the part. The two differ because of required cutouts, holes, and notches. At 1010, unique identifiers, referred to a “iges” numbers are assigned to each part and assembly. These numbers may be used to query a database for information about part or the job that uses that part.

At 1012, permanent program numbers are checked. At 1014, parts that are for production parts are checked. At 1016, iges files are generated. An iges file is a 2-dimensional (2-D) geometry file that may be used to program a turret punch to cut a part, or program lasers. In addition, iges data may be used as a common geometry format for transferring information between and among different CAD systems. At 1018, prints are generated. The prints may include bar code representing unique id numbers for the part or assembly, e.g., iges numbers. This bar code may be used for several purposes including querying a database for information about the part or job, and downloading programs to the turret punch or laser to cut the part. At 1020, the parts database is populated with information about the parts. This parts database information may be used for other application such as nesting applications.

In one embodiment, plot files are also created to be sent to the printer for each part and assembly requiring drawings. Plot files are not typically created for parts that have the production parameter set to “YES”, indicating that the part is one which is kept in stock on the shop floor. This method avoids producing surplus parts.

At 1022, the entire unit that includes all the parts is saved to a working directory. The working directory contains most of the parts used in the job, but there are some common parts that may not be initially copied to the directory when the job is built. This process insures that a copy of each part of subassembly used in the job is included in its directory, so that if it is unarchived in the future, changes to any common parts or assemblies will not affect the geometry of the job. This functionality may also be used in the nesting software. When a job is archived, its entire directory is archived. The directory contains all files required to produce that unit. In one embodiment, one unit is stored per directory.

When this process is completed, the user is notified that the unit or the equipment that the user configured is ready, e.g., by e-mail at 324. At this point, the part and assembly drawings are being printed on the printer that the user designated, if any, and the unit is ready to be sent to manufacturing for production.

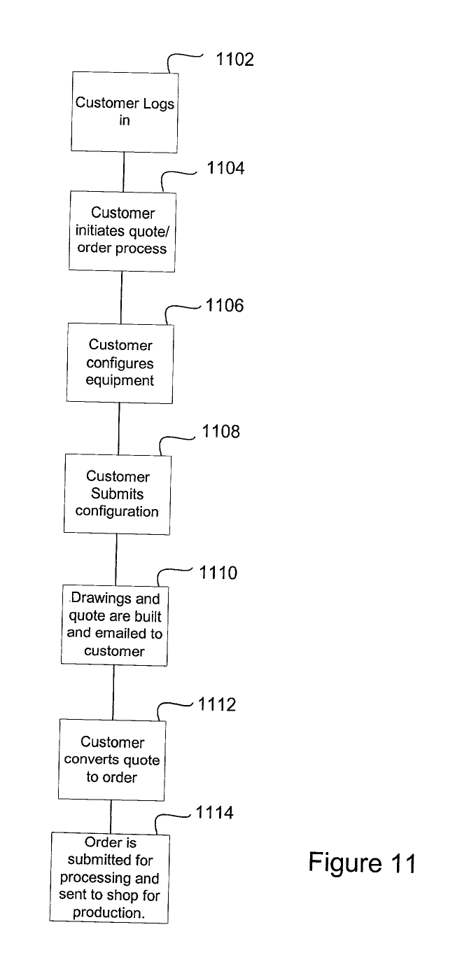

FIG. 11 is a flow diagram illustrating the ordering process in one embodiment of the present invention. At 1102, the customer logs in as described with reference to FIG. 1. At 1104, the customer initiates quotes and order process. At 1106, the customer then configure equipment. At 1108, the customer submits configuration to be planned and drawn. At 1110, drawings and quote are built and e-mailed to the customer. At this stage, the internal processing described with reference to FIG. 10 occurs such that when the customer converts the quote to an actual order, the production can be initiated seamlessly. At 1112, the customer converts quote to order. At 1114, the order is submitted for processing and sent to shop for production.

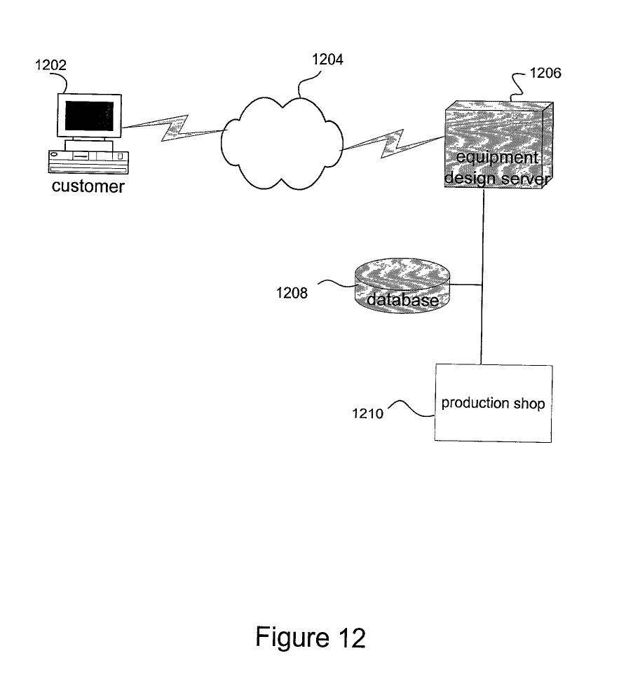

The present invention may be implemented over a computer network such as the World Wide Web using HTTP protocol, HTML, and JAVA enabled web browser. JavaScripts may be utilized to perform error or range checks on the fields that are entered by the customer. FIG. 12 shows an exemplary system of the present invention in one embodiment. A remote client 1202 running a web browser accesses the web site provided in the present invention via the Internet 1204 and logs on to the equipment design server 1206 of the present invention. The entered user name and password are transmitted to a server and a module that is responsible for validating the user login. With the information and hyperlinks displayed on the web page, a user is enabled to configure and receive e-mail of the configured equipment via a configuration module and mail module in the server 1206. In processing the customer requests, the server 1206 accesses the data stored in the database 1208. From the same web site, the user may order the configured equipment without entering any additional information. When the user selects to order the configured equipment, the order is submitted to the production shop 1210 for manufacturing.

While the invention has been particularly shown and described with respect to a preferred embodiment thereof, it will be understood by those skilled in the art that the foregoing and other changes in form and details may be made therein without departing from the spirit and scope of the invention. E.g., the method embodied in the present invention may be used to configure type of items. Further, the method and the system of the present invention may be implemented using any other computer system, network, and software.

We claim:

1. A method of designing and ordering equipment for manufacture on-line, comprising:
presenting a list of equipments to select for design on-line from a remote location over a computer network;
requesting design specification information for a selected equipment from the list of equipments;
automatically generating a drawing of the selected equipment based on the design specification information;
updating a manufacturing database with the design specification information needed for manufacturing the equipment;
sending the drawings to a customer for approval.

2. The method of claim 1, further including validating the customer permission before the presenting.

3. The method of claim 1, wherein the sending includes electronically mailing the drawings to the customer over the computer network.

4. The method of claim 1, wherein the computer network is the World Wide Web.

5. The method of claim 1, further including allowing the customer to initiate a purchase order for the equipment according to the design specification.

6. The method of claim 1, further including allowing the customer to receive the design specification at a later session.

7. The method of claim 1, further including allowing the customer to continue configuring equipment for order from a previous session.

8. The method of claim 1, wherein the generating a drawing includes generating separate drawings of parts comprising the equipment required for manufacturing the equipment.

9. The method of claim 1, wherein the generating a drawing further includes determining parts required for assembling the equipment.

10. The method of claim 1, wherein the generating a drawing includes computing parts information required for assembling the equipment.

11. The method of claim 1, wherein the updating includes updating all parts information required for assembling the equipment.

12. The method of claim 1, wherein the generating a drawing further includes generating a bar code to identify the drawing and printing the bar code on the drawing.

13. A program storage device readable by machine, tangibly embodying a program of instructions executable by the machine to perform method steps of designing and ordering equipment for manufacture on-line, comprising:
presenting a list of equipments to select for design on-line from a remote location over a computer network;
requesting design specification information for a selected equipment from the list of equipments;
automatically generating a drawing of the selected equipment based on the design specification information;
updating a manufacturing database with the design specification information used for manufacturing the equipment;
sending the drawings to a customer for approval.

14. A system for designing and ordering equipment for manufacture on-line, comprising:
a client web browser that communicates over a network to a remote server to initiate design and ordering of equipment for manufacture;
a server that requests and presents information to the client web browser, the information associated with the equipment, the server including:
a configuration module that presents a list of equipments to design to the client web browser, the configuration module further generating equipment drawing based on the information in response to a configuration request from the client web browser,
a mail module for transmitting the drawing over the network.

15. The system as claimed in claim 14, wherein the configuration module further generates parts information and drawings required for assembling the equipment.
